(19) United States
(12) Patent Application Publication
(10) Pub. No.: US 2026/0202777 A1
(43) Pub. Date: Jul. 16, 2026

(54) DEVELOPING DEVICE, IMAGE FORMING UNIT, AND IMAGE FORMING APPARATUS

(71) Applicants: Yusuke Yamasaki, Kanagawa (JP); Tatsuya Ohhira, Kanagawa (JP); Yumi Inoue, Kanagawa (JP); Yuuji Ishikura, Kanagawa (JP); Toshiki Hayashi, Kanagawa (JP); Tatsuya Kubo, Kanagawa (JP); Osamu Saito, Kanagawa (JP)

(72) Inventors: Yusuke Yamasaki, Kanagawa (JP); Tatsuya Ohhira, Kanagawa (JP); Yumi Inoue, Kanagawa (JP); Yuuji Ishikura, Kanagawa (JP); Toshiki Hayashi, Kanagawa (JP); Tatsuya Kubo, Kanagawa (JP); Osamu Saito, Kanagawa (JP)

(73) Assignee: ETRIA Co., Ltd., Kanagawa (JP)

(21) Appl. No.: 19/403,910

(22) Filed: Nov. 30, 2025

(30) Foreign Application Priority Data
Jan. 14, 2025 (JP) 2025-004823

(51) Int. Cl. G03G 15/08

(52) U.S. Cl. CPC G03G 15/0891; G03G 15/0889; G03G 2215/0827

(57) ABSTRACT

A developing device includes a developer bearer, a supply chamber, a first conveying screw, a collection chamber, and a second conveying screw. The developer bearer bears developer containing toner and carrier. The supply chamber stores the developer supplied to the developer bearer. The first conveying screw is in the supply chamber and supplies the developer to the developer bearer in a first direction. The collection chamber collects the developer. The second conveying screw is in the collection chamber and conveys the developer to the supply chamber in a second direction to circulate the developer between the supply chamber and the collection chamber. The supply chamber has an arc-shaped cross-sectional portion in a lower part of an inner surface of the supply chamber lower than a horizontal line passing through a rotation center of the first conveying screw. The arc-shaped cross-sectional portion follows a rotation trajectory of the first conveying screw.

### CROSS-REFERENCE TO RELATED APPLICATION

This patent application is based on and claims priority pursuant to 35 U.S.C. § 119(a) to Japanese Patent Application No. 2025-004823, filed on Jan. 14, 2025, in the Japan Patent Office, the entire disclosure of which is hereby incorporated by reference herein.

### BACKGROUND

### Technical Field

The present disclosure relates to a developing device, an image forming unit, and an image forming apparatus.

### Related Art

As an image forming apparatus such as a copier or a printer, an electrophotographic image forming apparatus is known in which a latent image is formed on a surface of a latent image bearer and developer is supplied to the latent image to develop the latent image. In such an electrophotographic image forming apparatus, a developing device that supplies developer to a surface of a latent image bearer is installed. The developing device includes, for example, a developer bearer that bears the developer and supplies the developer to the latent image bearer, and a conveying screw that conveys the developer supplied to the developer bearer.

### SUMMARY

The present disclosure described herein provides a developing device that includes a developer bearer, a supply chamber, a first conveying screw, a collection chamber, and a second conveying screw. The developer bearer bears developer containing toner and carrier. The supply chamber stores the developer supplied to the developer bearer. The first conveying screw is in the supply chamber, and conveys and supplies the developer to the developer bearer in the supply chamber in a first direction. The collection chamber collects the developer that has conveyed by the first conveying screw through the supply chamber. The second conveying screw is in the collection chamber and conveys the developer in the collection chamber to the supply chamber in a second direction opposite to the first direction to circulate the developer between the supply chamber and the collection chamber. The supply chamber has an arc-shaped cross-sectional portion having an arc-shaped cross-section in a cross section orthogonal to the first direction and in a lower part of an inner surface of the supply chamber lower than a horizontal line passing through a rotation center of the first conveying screw. The arc-shaped cross-sectional portion follows a rotation trajectory of the first conveying screw in the cross section.

The present disclosure described herein also provides an image forming unit that includes the developing device, and a latent image bearer to bear the developer supplied from the developing device on a surface of the latent image bearer.

The present disclosure described herein further provides an image forming apparatus that includes the image forming unit, and a latent forming device to form the latent image on the surface of the latent image bearer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image forming apparatus according to an embodiment of the present disclosure;

FIG. 2 is a cross-sectional view of a developing device according to the present embodiment;

FIG. 3 is a diagram illustrating an internal structure of the developing device illustrated in FIG. 2, as viewed from above in FIG. 2;

FIG. 4 is a diagram illustrating an example of a circumferential range in which an arc-shaped cross-sectional portion is provided; and

FIG. 5 is a cross-sectional view of a developing device according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In the drawings for illustrating embodiments of the present disclosure, identical or similar reference signs are assigned to elements such as components and parts that have identical or similar functions or shapes as far as distinguishable, and descriptions of such elements may be omitted once the description is provided. As used herein, the singular forms “a,” “an,” and “the” are intended to include the plural forms as well, unless the context clearly indicates otherwise.

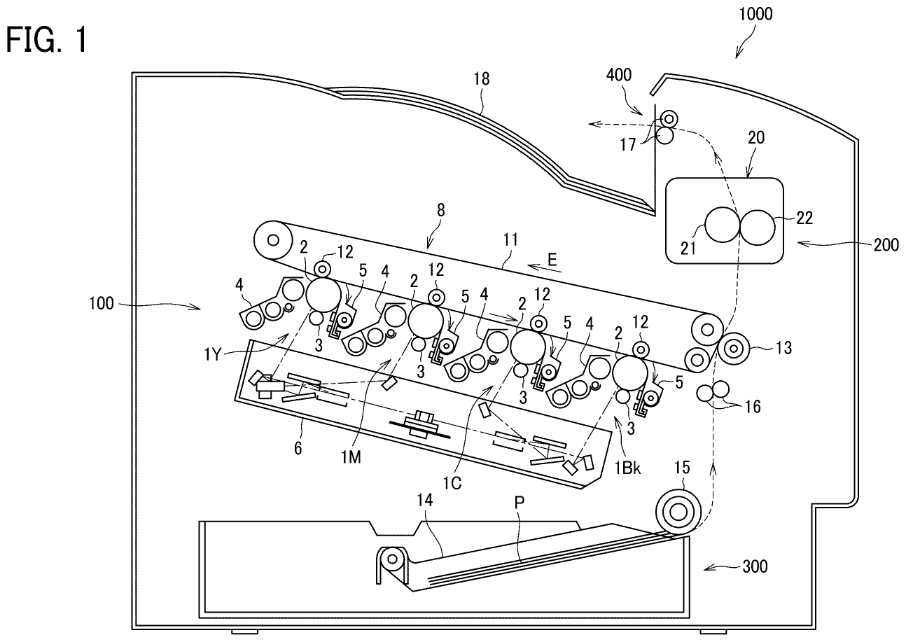

First, with reference to FIG. 1, a description is given of an image forming apparatus according to an embodiment of the present disclosure.

An image forming apparatus 1000 illustrated in FIG. 1 is an electrophotographic image forming apparatus that forms an image using two component developer (hereinafter, simply referred to as “developer”) including non-magnetic toner and magnetic carrier. The “image forming apparatus” according to an embodiment of the present disclosure includes a printer, a copier, a facsimile machine, a printing machine, and a multifunction peripheral combining two or more of thereof. The term “image formation” includes the formation of images with meanings such as characters and figures and the formation of images with no meanings such as patterns.

As illustrated in FIG. 1, the image forming apparatus 1000 according to the embodiment of the present disclosure includes an image forming device 100, a fixing unit 200, a sheet supplying device 300, and a sheet ejection device 400.

The image forming device 100 includes four image forming units 1Y, 1M, 1C, and 1Bk, an exposure device 6, and a transfer device 8.

The four image forming units 1Y, 1M, 1C, and 1Bk basically have the same configuration except for containing developers (toners) of different colors such as yellow, magenta, cyan, and black, respectively. Specifically, each of the image forming units 1Y, 1M, 1C, and 1Bk includes a photoconductor 2, a charger 3, a developing device 4, and a cleaning device 5.

The photoconductor 2 is, for example, a drum-shaped member that is driven to rotate, and is an example of a latent image bearer or an image bearer that bears a latent image or a toner image on the surface (outer circumferential surface). The photoconductor 2 may be a drum-shaped member or an endless belt.

The charger 3 is formed of a conductive or semiconductive charging roller that applies a voltage to the surface of the photoconductor 2 to uniformly charge the surface of the photoconductor 2. The charger 3 may be a contact type charger such as a magnetic brush, a fur brush, a film, or a rubber blade, or may be a non-contact type charger using corona discharge, in addition to the charging roller.

The developing device 4 is a device that supplies developer to the photoconductor 2. In this case, the developing device 4 stores developers (toners) of different colors for the multiple image forming units 1Y, 1M, 1C, and 1Bk.

The cleaning device 5 is a device that removes toner and other foreign substances remaining on the surface of the photoconductor 2. Specifically, the cleaning device 5 includes a cleaning blade that slides on the surface of the photoconductor 2, or a brush roller that rotates while contacting the surface of the photoconductor 2.

The exposure device 6 is an example of a latent image forming device that forms a latent image on the surface of the photoconductor 2. The exposure device 6 includes an optical system that irradiates the surface of the photoconductor 2 with laser light. Examples of the optical system include a copying optical system, a rod lens array system, a laser optical system, a liquid crystal shutter optical system, and a light-emitting diode (LED) optical system.

The transfer device 8 is a device that transfers an image onto a sheet as a recording medium from the photoconductor 2. A “sheet” is described as a “paper sheet”, but the “sheet” is not limited to paper (paper sheet), and may include an overhead projector (OHP) sheet, a fabric, a metal sheet, a plastic film, and a prepreg sheet in which carbon fibers are impregnated with a resin in advance. The “paper sheet” is not limited to plain paper, and may be thick paper, a postcard, an envelope, thin paper, coated paper (such as coated paper and art paper), and tracing paper.

Specifically, the transfer device 8 includes an intermediate transfer belt 11, primary transfer rollers 12, and a secondary transfer roller 13. The intermediate transfer belt 11 is an endless belt and is wound around and supported by multiple rollers including the primary transfer rollers 12. At least one of the multiple rollers supporting the intermediate transfer belt 11 functions as a drive roller, so that the intermediate transfer belt 11 is driven to rotate in a direction indicated by an arrow E in FIG. 1. The belt forming the intermediate transfer belt 11 may have a single-layer structure or a multi-layer structure. In the case of a multi-layer structure, a base layer made of fluororesin, polyvinylidene fluoride (PVDF), or polyimide resin with low elongation is preferably covered with a coating layer made of a material with good smoothness such as fluororesin. In the case of a single-layer structure, the belt is preferably made of, for example, PVDF, polycarbonate (PC), and polyimide.

Four primary transfer rollers 12 are disposed inside the intermediate transfer belt 11, and are arranged to face the respective photoconductors 2 via the intermediate transfer belt 11. Each of the primary transfer rollers 12 contacts the inner circumferential surface of the intermediate transfer belt 11 at a position facing the corresponding photoconductor 2, so that the intermediate transfer belt 11 contacts the photoconductor 2 to form a primary transfer nip. The primary transfer rollers 12 may be disposed at positions offset from the contact positions (primary transfer nips) between the photoconductors 2 and the intermediate transfer belt 11 toward the downstream side in the rotation direction of the surface of the intermediate transfer belt 11 by a specified distance, not limited to the case where the primary transfer rollers 12 are disposed in the positions facing the corresponding photoconductor 2 via the intermediate transfer belt 11.

The secondary transfer roller 13 is disposed to face one of the multiple rollers that support the intermediate transfer belt 11. The secondary transfer roller 13 contacts a roller facing the secondary transfer roller 13 via the intermediate transfer belt 11, so that a secondary transfer nip is formed between the secondary transfer roller 13 and the intermediate transfer belt 11.

The fixing unit 200 includes a fixing device 20 that heats a sheet to fix an image on the sheet. The fixing device 20 includes a fixing rotator 21 and a pressure rotator 22. The fixing rotator 21 is heated by a heat source such as a heater. The pressure rotator 22 contacts the fixing rotator 21 to form a fixing nip between the fixing rotator 21 and the pressure rotator 22.

The sheet supplying device 300 includes a sheet tray 14 and a feed roller 15. The sheet tray 14 stores sheets P. The feed roller 15 feeds the sheets P from the sheet tray 14 one by one.

The sheet ejection device 400 includes an ejection roller pair 17 and an output tray 18. The ejection roller pair 17 ejects the sheets P. The output tray 18 stacks the ejected sheets P.

With reference to FIG. 1, a description is given of an image forming operation of the image forming apparatus 1000 according to an embodiment of the present disclosure.

When the image forming operation is started, the photoconductors 2 in the image forming units 1Y, 1M, 1C, and 1Bk rotate in the direction indicated by the arrows in FIG. 1, and the surfaces of the photoconductors 2 are charged to a uniform high potential by the chargers 3. The exposure device 6 exposes the charged surface of each of the photoconductors 2 based on image data of a document read by a document reading device or print data instructed to print by a terminal. As a result, the electric potential at an exposed portion on the surface of each of the photoconductors 2 is decreased. Thus, an electrostatic latent image is formed on the surface of each of the photoconductors 2. Thereafter, toner is supplied from each of the developing devices 4 to each of the photoconductors 2, so that a toner image of each of colors is formed on each of the photoconductors 2.

The toner image formed on the photoconductor 2 reaches a primary transfer nip (the position of the primary transfer roller 12) as the photoconductor 2 rotates, and is transferred to the intermediate transfer belt 11. At this time, the toner images on the respective photoconductors 2 are sequentially transferred onto the intermediate transfer belt 11 that is driven to rotate in synchronization with the respective photoconductors 2, so that a full-color image in which the toner images of the respective colors are superimposed is formed. The image formation is not limited to the case of forming a full-color image, and a single-color image may be formed using any one of the four image forming units 1Y, 1M, 1C, and 1Bk, or a two-color image or a three-color image may be formed using any two or three of the image forming units of the four image forming units 1Y, 1M, 1C, and 1Bk. The photoconductor 2 after the image transfer is cleaned by the cleaning device 5. As a result, foreign substances such as residual toner are removed from the surface of each photoconductor 2.

The toner image transferred onto the intermediate transfer belt 11 reaches the secondary transfer nip (the position of the secondary transfer roller 13) with the rotation of the intermediate transfer belt 11, and is transferred onto the sheet at the secondary transfer nip. The sheet P is fed from the sheet supplying device 300. In other words, in the sheet supplying device 300, when the feed roller 15 is driven to rotate, the sheet P is fed from the sheet tray 14 and supplied to the secondary transfer nip. Specifically, after the sheet P fed from the sheet tray 14 is temporarily stopped by a timing roller pair 16 while the sheet P is conveyed to the secondary transfer nip, the timing roller pair 16 rotates at a specified timing to feed the sheet P to the secondary transfer nip in synchronization with the toner image on the intermediate transfer belt 11.

Thereafter, the sheet is conveyed to the fixing unit 200, and is heated and pressed when passing through the fixing nip between the fixing rotator 21 and the pressure rotator 22. As a result, the toner image on the sheet is fixed to the sheet. Then, the sheets P are conveyed to the sheet ejection device 400 and ejected to the outside of the apparatus by the ejection roller pair 17, and thus, stacked on the output tray 18. As described above, a series of image forming operations are completed.

A description is given of a problem in a developing device using the developing device according to a comparative example.

FIG. 5 is a diagram illustrating a configuration of a developing device 90 according to the comparative example.

First, A description is given of a configuration of the developing device 90 according to the comparative example. As illustrated in FIG. 5, the developing device 90 according to the comparative example includes a developing roller 91, a first conveying screw 92, and a second conveying screw 93.

The first conveying screw 92 is disposed in a supply chamber 94 of the developing device 90, and supplies developer to the developing roller 91 while conveying the developer in the supply chamber 94. The second conveying screw 93 is disposed in a collection chamber 95 different from the supply chamber 94, and conveys the developer in the collection chamber 95. The supply chamber 94 and the collection chamber 95 communicate with each other on the front side and the back side in FIG. 5. The first conveying screw 92 and the second conveying screw 93 convey the developer in opposite directions to each other, so that the developer is circulated and conveyed between the supply chamber 94 and the collection chamber 95. When the developer is conveyed by the first conveying screw 92, the developer is supplied to the surface of the developing roller 91 and is borne on the surface of the developing roller 91. When the developer supplied to the surface of the developing roller 91 is conveyed to a position facing a photoconductor 80 with the rotation of the developing roller 91, the toner in the developer is supplied to the latent image (electrostatic latent image) on the photoconductor 80, and then the latent image is developed as a toner image. The toner that is not supplied to the photoconductor 80 is separated from the developing roller 91 together with the carrier, and is collected in the supply chamber 94. The collected developer (toner and carrier) is conveyed to the collection chamber 95, and then is conveyed to the supply chamber 94 again to be supplied to the developing roller 91.

In the developing device 90 of the circulation conveyance type as in the comparative example, the developer is efficiently circulated and conveyed in order to stably supply the developer to the developing roller. In the developing device 90 according to a comparative example, as illustrated in FIG. 5, flat surfaces 96 and 97 are present in a portion below horizontal lines H1 and H2 including the rotation centers of the first conveying screw 92 and the second conveying screw 93 among the inner surfaces of the casing composing the supply chamber 94 and the collection chamber 95. Thus, an inconvenience that the developer is likely to stagnate in the flat surfaces 96 and 97 may occur. In other words, in a configuration in which the effective conveyance range of each of the first conveying screw 92 and the second conveying screw 93 is a circular region centered on a rotation center as in the comparative example, when the flat surfaces 96 and 97 are present in a lower region (a region below the horizontal lines H1 and H2) where the developer is present, a region where the conveyance force is less likely to act on the developer is generated. For example, in FIG. 5, in the flat surfaces 96 and 97 (corner portion 50) separated from the first conveying screw 92 and the second conveying screw 93, the conveyance force by the first conveying screw 92 and the second conveying screw 93 does not act on the developer, and thus immobile developer is generated.

As described above, in the developing device 90 according to the comparative example, the flat surfaces 96 and 97 are present in the lower region of the supply chamber 94 and the collection chamber 95, the developer is likely to stagnate. Thus, an inconvenience that the developer is not efficiently circulated and conveyed may occur.

In the present disclosure, the following configuration of the developing device is proposed in order to restrict the developer from stagnating in the developing device and to efficiently circulate and convey the developer. A description is given below of a configuration of a developing device according to an embodiment of the present disclosure.

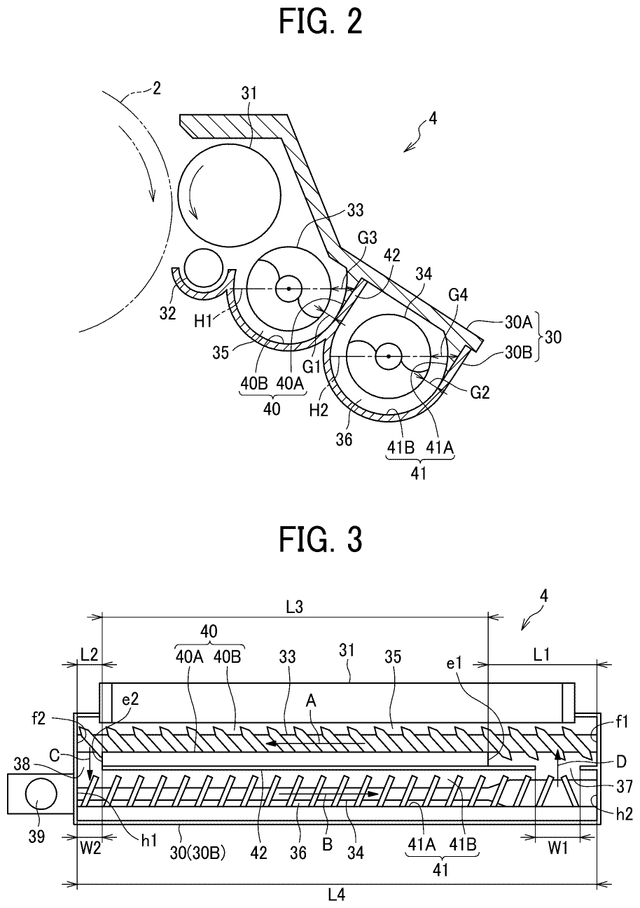

FIG. 2 is a cross-sectional view of the developing device 4 according to an embodiment of the present disclosure. FIG. 3 is a plan view of an internal structure of the developing device 4 illustrated in FIG. 2, as viewed from above in FIG. 2.

First, with reference to FIGS. 2 and 3, a description is given of a basic structure of the developing device 4.

As illustrated in FIG. 2, the developing device 4 according to the present embodiment includes a casing 30, a developing roller 31, a restricting roller 32, a first conveying screw 33, and a second conveying screw 34.

In this case, the casing 30 has a lid-shaped upper case 30A and a container-shaped lower case 30B. The upper case 30A and the lower case 30B are united with each other. The casing 30 may be integrally molded.

The developing roller 31 is an example of a developer bearer that bears developer on the surface of the developing roller 31. The developing roller 31 is disposed to face the photoconductor 2 through an opening of the casing 30.

The restricting roller 32 is an example of a restricting member that restricts the amount of developer carried on the surface of the developing roller 31. The restricting roller 32 is disposed to face the surface of the developing roller 31 with a specified gap therebetween. Instead of the restricting roller 32, for example, a blade-shaped restricting member may be used.

The first conveying screw 33 and the second conveying screw 34 are conveying members each having a spiral blade on the outer circumferential surface of the rotation center. The first conveying screw 33 is disposed in a supply chamber 35 of the casing 30 and conveys the developer in the supply chamber 35. On the other hand, the second conveying screw 34 is disposed in a collection chamber 36 different from the supply chamber 35 and conveys the developer in the collection chamber 36.

As illustrated in FIG. 3, the first conveying screw 33 and the second conveying screw 34 convey the developer in opposite directions (in the directions indicated by the arrow A and the arrow B). In this case, the first conveying screw 33 conveys the developer from the right toward the left (in the direction indicated by the arrow A) in FIG. 3, and the second conveying screw 34 conveys the developer from the left toward the right (in the direction indicated by the arrow B) in FIG. 3.

The supply chamber 35 and the collection chamber 36 communicate with each other via a supply port 37 and a collection port 38 provided on both ends of a partition 42 that partitions the supply chamber 35 and the collection chamber 36. Accordingly, when the developer is conveyed by the first conveying screw 33, the developer is conveyed from the supply chamber 35 to the collection chamber 36 (in the direction indicated by the arrow C) via the collection port 38. When the developer is conveyed by the second conveying screw 34, the developer is conveyed from the collection chamber 36 to the supply chamber 35 (in the direction indicated by the arrow D) via the supply port 37. As described above, the developer is conveyed in the opposite directions by the first conveying screw 33 and the second conveying screw 34, and circulates by moving back and forth between the supply chamber 35 and the collection chamber 36 via the supply port 37 and the collection port 38.

When the developer is conveyed by the first conveying screw 33, the developer is borne on the surface of the developing roller 31 that rotates. Specifically, when the developer is conveyed by the first conveying screw 33, the toner in the developer is charged by friction with the carrier. Thus, the charged toner is attracted to the surface of the developing roller 31 together with the carrier by the magnetic force of the developing roller 31.

When the developer (toner and carrier) on the developing roller 31 reaches the position of the restricting roller 32 with the rotation of the developing roller 31, the developer passes between the developing roller 31 and the restricting roller 32, so that the excessive developer is scraped off. As a result, an appropriate amount of developer is borne on the surface of the developing roller 31.

Thereafter, when the developer on the developing roller 31 reaches a position (developing region) facing the photoconductor 2, the toner is supplied to the latent image on the photoconductor 2 by an electric field formed between the developing roller 31 and the photoconductor 2. As a result, the latent image is developed as a toner image.

The developer including the toner that is not supplied to the surface of the photoconductor 2 is separated from the developing roller 31 and is collected in the supply chamber 35. The collected developer is conveyed by the first conveying screw 33 and the second conveying screw 34, and is supplied again to the supply chamber 35.

When the toner in the developing device 4 is consumed, the toner is supplied from a toner container installed in the image forming apparatus to the developing device 4. As illustrated in FIG. 3, in the developing device 4 according to the present embodiment, a replenishment port 39 for replenishing toner is provided at an upstream end of the collection chamber 36 in a developer conveyance direction B. When the amount of the toner in the developing device 4 is equal to a certain amount or less, the toner is replenished from a toner container to the collection chamber 36 via the replenishment port 39. The toner replenished to the collection chamber 36 is conveyed together with the developer in the collection chamber 36 while being stirred by the second conveying screw 34. As a result, the replenished toner and the present developer are mixed, and then the developer having a uniform toner concentration is supplied to the supply chamber 35.

Next, a description is given of a configuration of the developing device 4 according to the present embodiment.

As illustrated in FIG. 2, in the developing device 4 according to the present embodiment, the entire lower portion, in which the developer is typically present, of the supply chamber 35 and the collection chamber 36, has an arc-shaped cross section. In other words, as illustrated in FIG. 2, in a cross section in a direction orthogonal to the rotation center of each of the first conveying screw 33 and the second conveying screw 34, an entire portion of an inner surface of the collection chamber 36 below horizontal lines H1 and H2 including a rotation center of the first conveying screw 33 and the second conveying screw 34 has an arc-shaped cross section following rotation trajectories of the first conveying screw 33 and the second conveying screw 34. The “lower portion” of the horizontal lines H1 and H2 means a portion lower than the horizontal lines H1 and H2 in the gravity direction.

In the present embodiment, the casing 30 includes the upper case 30A and the lower case 30B united with each other. Portions of arc-shaped cross sections 40 and 41 of the supply chamber 35 and the collection chamber 36 (hereinafter referred to as “arc-shaped cross-sectional portions”) include arc-shaped cross-sectional portions 40A and 41A provided on the upper case 30A, and arc-shaped cross-sectional portions 40B and 41B provided on the lower case 30B. The arc-shaped cross-sectional portions 40A and 41A provided on the upper case 30A may be integrally molded with the arc-shaped cross-sectional portions 40B and 41B provided on the lower case 30B. When the upper case 30A and the lower case 30B are molded using a mold, it is preferable that the arc-shaped cross-sectional portions 40A and 41A are separately molded on the upper case 30A and the lower case 30B in order to facilitate extraction of the molded product (the upper case 30A and the lower case 30B) from the mold.

As described above, in the present embodiment, the entire portion below the horizontal lines H1 and H2 including the rotation center of each of the first conveying screw 33 and the second conveying screw 34 has an arc-shaped cross section following the rotation trajectories of the first conveying screw 33 and the second conveying screw 34. Thus, the developer is less likely to stagnate in the supply chamber 35 and the collection chamber 36. In other words, in the present embodiment, the entire portion below the horizontal lines H1 and H2 including the rotation center of each of the first conveying screw 33 and the second conveying screw 34, and has an arc-shaped cross section, a flat portion is not present in the lower portion where the developer is mainly present, and thus the stagnation of the developer as in the comparative example is less likely to occur. Thus, the immobile developer can be reduced. In the present embodiment, such a configuration can efficiently convey the developer in the developing device 4, and can stably supply the developer to the developing roller 31.

In order to effectively apply the conveyance force of each of the first conveying screw 33 and the second conveying screw 34 to the developer, it is preferable that the arc-shaped cross sections 40 and 41 are provided as close as possible to each of the first conveying screw 33 and the second conveying screw 34 to the extent that the arc-shaped cross sections 40 and 41 do not contact the first conveying screw 33 and the second conveying screw 34. In the present embodiment, in the region of the supply chamber 35 below the horizontal line H1 including the rotation center of the first conveying screw 33, a maximum distance G3 (see FIG. 2) between the portion of the lower case 30B that does not have an arc-shaped cross section and an end of the outermost diameter of the first conveying screw 33 (the outermost circumferential surface of the blade) is 4.75 mm. In contrast, a distance G1 (see FIG. 2) between the arc-shaped cross section 40 and the outermost radial end of the first conveying screw 33 is 1.2 mm. In the region of the collection chamber 36 below the horizontal line H2 including the rotation center of the second conveying screw 34, a maximum distance G4 (see FIG. 2) between the portion of the lower case 30B that does not have an arc-shaped cross section and the end of the outermost diameter of the second conveying screw 34 (the outermost circumferential surface of the blade) is 4.60 mm. In contrast, a distance G2 (see FIG. 2) between the arc-shaped cross section 41 and the end of the outermost diameter of the second conveying screw 34 is 1.5 mm.

As described above, in the present embodiment, the distances G1 and G2 between the respective arc-shaped cross sections 40 and 41, and each of the first conveying screw 33 and the second conveying screw 34 are smaller than the maximum distances G3 and G4 between the portions not having the arc-shaped cross section and each of the first conveying screw 33 and the second conveying screw 34 (G1<G3, and G2<G4), so that the conveying force of each of the first conveying screw 33 and the second conveying screw 34 can be effectively exerted on the developer. In the present embodiment, the conveyance speed of the developer can be increased, and the occurrence of immobile developer can be effectively reduced.

The reason why the distance G2 between the arc-shaped cross section 41 of the collection chamber 36 and the outermost end of the second conveying screw 34 is larger than the distance G1 between the arc-shaped cross section 40 of the supply chamber 35 and the end of the outermost diameter of the first conveying screw 33 (G2>G1) is that the developer can be preferably stirred in the collection chamber 36. In other words, when the distance G2 between the arc-shaped cross section 41 of the collection chamber 36 and the end of the outermost diameter of the second conveying screw 34 is too small, there is a risk that the developer cannot be stirred well when the toner is supplied. Thus, in the present embodiment, the distance G2 between the arc-shaped cross section 41 of the collection chamber 36 and the end of the outermost diameter of the second conveying screw 34 is larger than the distance G1 between the arc-shaped cross section 40 of the supply chamber 35 and the end of the outermost diameter of the first conveying screw 33 (G2>G1), so that a stirring space of the developer in the collection chamber 36 is maintained.

In order to reduce the variation in the conveyance force of the first conveying screw 33 to the developer, it is preferable that the distance G1 between the arc-shaped cross section 40 of the supply chamber 35 and the end of the outermost diameter of the first conveying screw 33 is substantially same (constant) in both the rotation direction of the first conveying screw 33 and a developer conveyance direction A. Similarly, it is preferable that the distance G2 between the arc-shaped cross section 41 of the collection chamber 36 and the end of the outermost diameter of the second conveying screw 34 is substantially same (constant) in both the rotation direction of the second conveying screw 34 and the developer conveyance direction B. The distances G1 and G2 are equalized in both the rotational direction and the developer conveyance directions A and B, so that the variation in the conveying force of the first conveying screw 33 and the second conveying screw 34 with respect to the developer can be reduced. Thus, the developer can be supplied more efficiently and stably. In order to equalize the distances G1 and G2 in the rotation direction, the center of each of the arc-shaped cross sections 40 and 41, and the rotation center of each of the first conveying screw 33 and the second conveying screw 34 are arranged to coincide with each other. In the present disclosure, the center of each of the arc-shaped cross sections 40 and 41 (the center of a circle including an arc portion) and the rotation center of each of the first conveying screw 33 and the second conveying screw 34 are not limited to a case of completely coinciding with each other, and may be arranged to be slightly deviated from each other. Even in a case where the center of the arc-shaped cross sections 40 and 41, and the rotation centers of the first conveying screw 33 and the second conveying screw 34 are disposed to be slightly deviated from each other, when the entire portion below the horizontal lines H1 and H2 including the rotation center of the first conveying screw 33 and the second conveying screw 34 is formed in the arc-shaped cross sections 40 and 41 following the rotation trajectories of the first conveying screw 33 and the second conveying screw 34 as described above, the stagnation of the developer can be restricted and the immobile developer can be reduced as compared with the comparative example.

As illustrated in FIG. 3, in the present embodiment, the arc-shaped cross sections 40 and 41 of the supply chamber 35 and the collection chamber 36 are continuously provided in the longitudinal direction of the supply chamber 35 and the collection chamber 36. The arc-shaped cross-sectional portion 40A provided in the supply chamber 35 and the arc-shaped cross-sectional portion 41A provided in the collection chamber 36 of the arc-shaped cross-sectional portions 40A and 41A provided on the upper case 30A have different lengths of the arrangement range.

The arc-shaped cross-sectional portion 40A provided in the supply chamber 35 is provided adjacent to the partition 42 of the lower case 30B that partitions between the supply chamber 35 and the collection chamber 36, so that the arc-shaped cross-sectional portion 40A is provided at a position different from the supply port 37 and the collection port 38 not to block the supply port 37 and the collection port 38 provided on both ends in the longitudinal direction of the partition 42. In this case, the arc-shaped cross-sectional portion 40A provided in the supply chamber 35 is continuously provided from a position slightly downstream of the supply port 37 to a position of an upstream end of the collection port 38 with respect to the developer conveyance direction A.

An upstream end e1 of the arc-shaped cross-sectional portion 40A provided in the supply chamber 35 is provided at a position spaced downstream from the supply port 37 in order not to prevent the developer from being conveyed into the supply chamber 35 through the supply port 37. In the present embodiment, the developer in the collection chamber 36 is lifted up by the second conveying screw 34 and is conveyed to the supply chamber 35. When the arc-shaped cross-sectional portion 40A is provided in the vicinity of the supply port 37 in a projection manner, here is a concern that smooth conveyance of the developer is hindered by the arc-shaped cross-sectional portion 40A. Accordingly, in the present embodiment, the arc-shaped cross-sectional portion 40A provided in the supply chamber 35 is provided at a position spaced downstream from the supply port 37 with respect to the developer conveyance direction A. In order not to hinder the conveyance of the developer into the supply port 37, a distance L1 (see FIG. 3) from an upstream end f1 of the supply chamber 35 in the developer conveyance direction A to the upstream end e1 of the arc-shaped cross-sectional portion 40A is preferably in a range of twice or more and 2.5 times or less of a width W1 of the supply port 37. In the present embodiment, the distance L1 from the upstream end f1 of the supply chamber 35 to the upstream end e1 of the arc-shaped cross-sectional portion 40A is set to 30 mm corresponding to 2.5 times the width W1 (12 mm) of the supply port 37. On the other hand, a downstream end e2 of the arc-shaped cross-sectional portion 40A may be provided close to the collection port 38. In the collection port 38, the developer may be simply dropped from the supply chamber 35 to the collection chamber 36, even if the arc-shaped cross-sectional portion 40A is provided close to the collection port 38, there is little concern that conveyance of the developer from the supply chamber 35 is hindered. Accordingly, in the present embodiment, the distance L2 (see FIG. 3) from the downstream end e2 of the arc-shaped cross-sectional portion 40A in the developer conveyance direction A to the downstream end f2 of the supply chamber 35 is set to 6.5 mm, which is the same as the width W2 (6.5 mm) of the collection port 38.

Next, in the collection chamber 36, the arc-shaped cross-sectional portion 41A is not provided adjacent to the partition 42 unlike the arc-shaped cross-sectional portion 40A provided in the supply chamber 35 as described above. Thus, even when the arc-shaped cross-sectional portion 41A is extended, there is no concern that the supply port 37 and the collection port 38 are blocked. For this reason, in the present embodiment, the arc-shaped cross-sectional portion 41A provided in the collection chamber 36 is provided over the entire region from the upstream end h1 to the downstream end h2 of the collection chamber 36 in the developer conveyance direction B, and is formed to be longer than the arc-shaped cross-sectional portion 40A provided in the supply chamber 35. Accordingly, the size L4 (see FIG. 3) in the longitudinal direction (the size in the developer conveyance direction B) of the arc-shaped cross-sectional portion 41A provided in the collection chamber 36 is set to the same size 240 mm as the size (240 mm) in the longitudinal direction of the collection chamber 36. On the other hand, the size L3 (see FIG. 3) in the longitudinal direction (the size in the developer conveyance direction A) of the arc-shaped cross-sectional portion 40A provided in the supply chamber 35 is set to 203.5 mm, which is shorter than the size L3 (240 mm) in the longitudinal direction of the supply chamber 35.

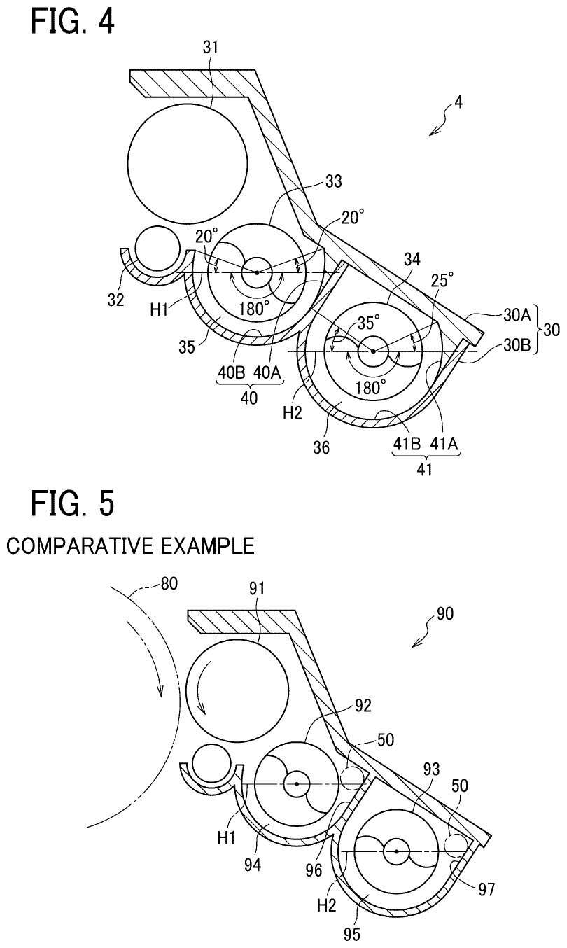

FIG. 4 is a diagram illustrating an example of a circumferential range in which the arc-shaped cross sections 40 and 41 are provided. The “circumferential range” is a range in the rotation direction of each of the first conveying screw 33 and the second conveying screw 34.

In the supply chamber 35 illustrated in FIG. 4, the arc-shaped cross section 40 is continuously provided over a range of 20 degrees to the right and 20 degrees to the left above the horizontal line H1 in addition to the entire range of 180 degrees below the horizontal line H1 including the rotation center of the first conveying screw 33. On the other hand, in the collection chamber 36, the arc-shaped cross section 41 is continuously provided over a range of 25 degrees to the right and 35 degrees to the left above the horizontal line H2 in addition to the entire range of 180 degrees below the horizontal line H2 including the rotation center of the second conveying screw 34. The reason why the arc-shaped cross section 40 of the supply chamber 35 in the circumferential range is smaller than the arc-shaped cross section 41 of the collection chamber 36 is that an opening width between the first conveying screw 33 and the developing roller 31 is maintained to facilitate the supply of the developer from the first conveying screw 33 to the developing roller 31. However, the circumferential range of each of the arc-shaped cross sections 40 and 41 is not limited to the example of FIG. 4, and can be appropriately changed, for example, according to the shape of the casing 30 and the component layout.

Although an embodiment of the present disclosure has been described above, embodiments of the present disclosure are not limited to the above embodiments. In the above-described embodiment, the distances G1, G2, G3, and G4 between the first conveying screw 33 and the second conveying screw 34, and the inner surface of the casing 30 (see FIG. 2), the widths W1 and W2 of the supply port 37 and the collection port 38 (see FIG. 3), the distances L1 and L2 in the developer conveyance direction A between the casing 30 and the arc-shaped cross-sectional portion 40A (see FIG. 3), and the dimensions L3 and L4 of the arc-shaped cross-sectional portions 40A and 41A in the longitudinal direction, were described with specific numerical values. However, these numerical values are not limited to the above-described examples.

In the above-described embodiments, the constitution of the present disclosure is described with an example of the developing device using two conveying screws (the first conveying screw 33 and the second conveying screw 34). However, the present disclosure is also applicable to a developing device using three or more conveying screws.

In the above-described embodiment, the case where the arc-shaped cross sections 40 and 41 according to the disclosure is provided in both the supply chamber 35 and the collection chamber 36 is described as an example. However, the arc-shaped cross section 40 according to the disclosure may be provided in the supply chamber 35. When the supply chamber 35 is provided with at least the arc-shaped cross section 40 according to the present disclosure, the developer conveyance efficiency in the supply chamber 35 can be enhanced as compared with the comparative example. Thus, the stable supply of the developer to the developing roller 31, which is the object of the present disclosure, can be achieved.

The above-described embodiments of the present disclosure include at least the following aspects.

### First Aspect

A developing device (e.g., the developing device 4) includes a developer bearer (e.g., the developing roller 31), a supply chamber (e.g., the supply chamber 35), a first conveying screw (e.g., the first conveying screw 33), a collection chamber (e.g., the collection chamber 36), and a second conveying screw (e.g., the second conveying screw 34). The developer bearer bears two-component developer containing toner and carrier. The supply chamber stores the developer to be supplied to the developer bearer. The first conveying screw supplies the developer to the developer bearer while conveying the developer in the supply chamber. The collection chamber collects the developer having passed through the supply chamber. The second conveying screw conveys the developer in the collection chamber. The first conveying screw and the second conveying screw circulate and convey the developer between the supply chamber and the collection chamber. In a cross section perpendicular to a rotation center of the first conveying screw, the entire portion of an inner surface of the supply chamber below a horizontal line including a rotation center of the first conveying screw has an arc-shaped cross section that follows a rotation trajectory of the first conveying screw.

### Second Aspect

In the developing device (e.g., the developing device 4) according to the first aspect, a portion having the arc-shaped cross section (e.g., the arc-shaped cross section 40) of the supply chamber (e.g., the supply chamber 35) is located at the same distance from an end of the outermost diameter of the first conveying screw (e.g., the first conveying screw 33) in both a rotation direction and a developer conveyance direction A of the first conveying screw.

### Third Aspect

In the developing device (e.g., the developing device 4) according to the first or second aspect, in a region below a horizontal line including a rotation center of the first conveying screw (e.g., the first conveying screw 33), a distance between a portion having the arc-shaped cross section of the supply chamber (e.g., the supply chamber 35) and the end of the outermost diameter of the first conveying screw is smaller than a maximum distance between a portion not having the arc-shaped cross section of the supply chamber and the end of the outermost diameter of the first conveying screw.

### Fourth Aspect

In the developing device (e.g., the developing device 4) according to any one of the first to third aspects, the portion having the arc-shaped cross section of the supply chamber (e.g., the supply chamber 35) is provided on a downstream side in a conveyance direction with respect to a supply port (e.g., the supply port 37) through which the developer is conveyed from the collection chamber (e.g., the collection chamber 36) to the supply chamber. A distance from an upstream end of the supply chamber in the developer conveyance direction A to an upstream end of the portion having the arc-shaped cross section is within a range of twice or more and 2.5 times or less of a width of the supply port.

### Fifth Aspect

In the developing device (e.g., the developing device 4) according to any of the first to fourth aspects, in a cross section in a direction orthogonal to a rotation center of the second conveying screw (e.g., the second conveying screw 34), an entire portion of an inner surface of the collection chamber (e.g., the collection chamber 95) below a horizontal line including the rotation center of the second conveying screw has an arc-shaped cross section following a rotation trajectory of the second conveying screw.

### Sixth Aspect

In the developing device (e.g., the developing device 4) according to the fifth aspect, the portion having the arc-shaped cross section of the collection chamber (e.g., the collection chamber 36) is disposed at the same distance from an end of the outermost diameter of the second conveying screw (e.g., the second conveying screw 34) in both the rotation direction of the second conveying screw and the developer conveyance direction B.

### Seventh Aspect

In the developing device (e.g., the developing device 4) according to the fifth or sixth aspect, the portion of the collection chamber (e.g., the collection chamber 95) having the arc-shaped cross section (e.g., the arc-shaped cross section 41) is provided over an entire region from an upstream end to a downstream end of the collection chamber in the developer conveyance direction B.

### Eighth Aspect

In the developing device (e.g., the developing device 4) according to any one of the fifth to seventh aspects, a distance between a portion having the arc-shaped cross section of the collection chamber (e.g., the collection chamber 36) and the end of the outermost diameter of the second conveying screw (e.g., the second conveying screw 34) is larger than a distance between a portion having the arc-shaped cross section of the supply chamber (e.g., the supply chamber 35) and the end of the outermost diameter of the first conveying screw (e.g., the first conveying screw 33).

### Ninth Aspect

An image forming unit (e.g., the image forming units 1Y, 1M, 1C, and 1Bk) includes a latent image bearer (e.g., the photoconductor 2) that bears a latent image on a surface of the latent image bearer, and a developing device (e.g., the developing device 4) that supplies developer to the latent image on the latent image bearer. The image forming unit is attachable to and detachable from a body of an image forming apparatus (e.g., the image forming apparatus 100) and includes the developing device (e.g., the developing device 4) according to any one of the first to eighth aspects as the developing device.

### Tenth Aspect

An image forming apparatus (e.g., the image forming apparatus 100) includes a latent image bearer (e.g., the photoconductor 2) that bears a latent image on a surface of the latent image bearer, a latent image forming device (e.g., the exposure device 6) that forms the latent image on the surface of the latent image bearer, and a developing device (e.g., the developing device 4) that supplies developer to the latent image on the latent image bearer. The developing device is the developing device according to any one of the first to eighth aspects as the developing device.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device comprising:
a developer bearer to bear developer containing toner and carrier;
a supply chamber to store the developer supplied to the developer bearer;
a first conveying screw in the supply chamber, the first conveying screw to convey and supply the developer to the developer bearer in the supply chamber in a first direction;
a collection chamber to collect the developer that has conveyed by the first conveying screw through the supply chamber; and
a second conveying screw in the collection chamber, the second conveying screw to convey the developer in the collection chamber to the supply chamber in a second direction opposite to the first direction to circulate the developer between the supply chamber and the collection chamber,
wherein the supply chamber has an arc-shaped cross-sectional portion having an arc-shaped cross-section:
in a cross section orthogonal to the first direction; and
in a lower part of an inner surface of the supply chamber lower than a horizontal line passing through a rotation center of the first conveying screw, and
the arc-shaped cross-sectional portion follows a rotation trajectory of the first conveying screw in the cross section.

2. The developing device according to claim 1,
wherein the arc-shaped cross-sectional portion has a constant distance from an outermost edge of the first conveying screw to an inner wall of the supply chamber:
around a rotation direction of the first conveying screw; and
in the first direction of the first conveying screw.

3. The developing device according to claim 1,
wherein the supply chamber further includes a flat surface portion in the cross section, and
the supply chamber has, in the lower part of the inner surface of the supply chamber:
a first distance between an outermost edge of the first conveying screw and an inner wall of the arc-shaped cross-sectional portion; and
a second distance between the outermost edge of the first conveying screw and the flat surface portion, the second distance larger than the first distance.

4. The developing device according to claim 1,
wherein the supply chamber has a supply port through which developer is conveyed from the collection chamber to the supply chamber,
the arc-shaped cross-sectional portion is disposed downstream from the supply port in the first direction, and
the supply chamber has a distance, in the first direction, from an upstream end of the supply chamber to an upstream end of the arc-shaped cross-sectional portion within a range of twice or more and 2.5 times or less of a width of the supply port.

5. The developing device according to claim 1,
wherein the collection chamber has an arc-shaped cross-sectional portion having an arc-shaped cross-section:
in a cross section orthogonal to the second direction; and
in a lower part of an inner surface of the collection chamber lower than a horizontal line passing through a rotation center of the second conveying screw, and
the arc-shaped cross-sectional portion follows a rotation trajectory of the second conveying screw in the cross section.

6. The developing device according to claim 5,
wherein the arc-shaped cross-sectional portion has a constant distance from an outermost edge of the second conveying screw to an inner wall of the supply chamber:
around a rotation direction of the second conveying screw; and
in the second direction of the second conveying screw.

7. The developing device according to claim 5,
wherein the collection chamber includes the arc-shaped cross-sectional portion formed from an upstream end to a downstream end of the collection chamber in the second direction.

8. The developing device according to claim 5,
wherein the supply chamber has a first distance between the arc-shaped cross-sectional portion and an outermost edge of the first conveying screw,
the collection chamber has a second distance between the arc-shaped cross-sectional portion and an outer edge of the second conveying screw, and
the second distance is larger than the first distance.

9. An image forming unit comprising:
the developing device according to claim 1; and
a latent image bearer to bear the developer supplied from the developing device on a surface of the latent image bearer.

10. An image forming apparatus comprising:
the image forming unit according to claim 9; and
a latent image forming device to form a latent image on the surface of the latent image bearer.
